(19) United States
(12) Patent Application Publication
(10) Pub. No.: US 2014/0231195 A1
(43) Pub. Date: Aug. 21, 2014

(54) TUNED VIBRATION DAMPED DEVICE

(71) Applicant: GM GLOBAL TECHNOLOGY OPERATIONS LLC, Detroit, MI (US)

(72) Inventor: James Amari, Yarraville (AU)

(73) Assignee: GM Global Technology Operations LLC, Detroit, MI (US)

(21) Appl. No.: 13/768,272

(22) Filed: Feb. 15, 2013

(51) Int. Cl. F16D 65/12; F16F 7/10

(52) U.S. Cl. CPC F16D 65/123; F16F 7/10; F16D 65/12
USPC 188/218 XL; 74/572.21

(57) ABSTRACT

A number of variations may include a casting including a body portion and a mass damper extending therefrom wherein the body portion and the mass damper are a continuous un-joined single piece of cast metal, and wherein the mass dampers constructed and arranged to prevent or retard vibrations of the body portion. A number of variations may include a vented brake rotor including a hub and a first annular portion extending from the hub; the annular portion including a first rotor cheek, a second rotor cheek spaced apart from the first rotor cheek and at least one rib extending between the first rotor cheek and the second rotor cheek; a mass damper disposed between the first rotor cheek and the second rotor cheek. A number of variations may include a casting including a body portion and a mass damper extending therefrom wherein the body portion and the mass damper are a continuous un-joined single piece of cast metal, and wherein the mass damper is constructed and arranged to prevent or retard vibrations of the body portion.

### TECHNICAL FIELD

The field to which the disclosure generally relates to includes tuned vibration damped devices.

### BACKGROUND

Parts subjected to vibration may produce unwanted or undesirable vibrations or noises.

### SUMMARY OF ILLUSTRATIVE VARIATIONS OF THE INVENTION

A number of variations may include a casting including a body portion and a mass damper extending therefrom wherein the body portion and the mass damper are a continuous un-joined single piece of cast metal, and wherein the mass damper is constructed and arranged to prevent or retard vibrations of the body portion.

A number of variations may include a vented brake rotor including a hub and a first annular portion extending from the hub; the annular portion including a first rotor cheek, a second rotor cheek spaced apart from the first rotor cheek and at least one rib extending between the first rotor cheek and the second rotor cheek; a mass damper disposed between the first rotor cheek and the second rotor cheek.

A number of variations may include a casting including a body portion and a mass damper extending therefrom wherein the body portion and the mass damper are a continuous un-joined single piece of cast metal, and wherein the mass damper is constructed and arranged to prevent, reduce or retard vibrations of the body portion.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is a sectional view of a product according to one variation of the invention;

FIG. 2 is a sectional view of a product according to one variation of the invention;

FIG. 3 is a sectional view of a product according to one variation of the invention;

FIG. 4 is a sectional view of a product according to one variation of the invention;

FIG. 5 is a sectional view of a product according to one variation of the invention;

FIG. 6 is a sectional view of a product according to one variation of the invention;

FIG. 7 is a sectional view of a product according to one variation of the invention; and

FIG. 8 is a sectional view of a product according to one variation of the invention.

### DETAILED DESCRIPTION OF ILLUSTRATIVE VARIATIONS OF THE INVENTION

The following description of the variations is merely illustrative in nature and is in no way intended to limit the invention, its application, or uses.

In a number of variations, a part 10 may have various geometric, dimensional, and structural configurations The part 10 may be made from any of a variety of materials including, but not limited to, at least one of cast iron, steel, aluminum, titanium, or other metallic/non-metallic (ceramic or refractory) materials. The part 10 may be subject to vibration/dynamic loading during use including, for example, but not limited to, use as a brake rotor, brake hub, pulley, gear, shaft, bearing, engine, baseball bat, lathe machine, milling machine, drilling machine, or grinding machine. The part 10 may be damped for use, for example but not limited to, within automotive applications.

A number of variations of the invention are illustrated by FIG. 1, including a part 10, which may include a hub 12 and an annular body 14. The annular body 14 may include a plurality of ribs 20 and a plurality of mass dampers 22. The mass dampers 22 may each individually include a protrusion or jut 24 extending from an anchor portion 23. The protrusion of jut 24 may have a free end 25. The mass dampers 22 may be constructed and arranged to function as tuned vibration absorbers. The mass dampers 22 may be made from at least one of a metal, composite material, thermoplastic material, thermoset material or ceramic material.

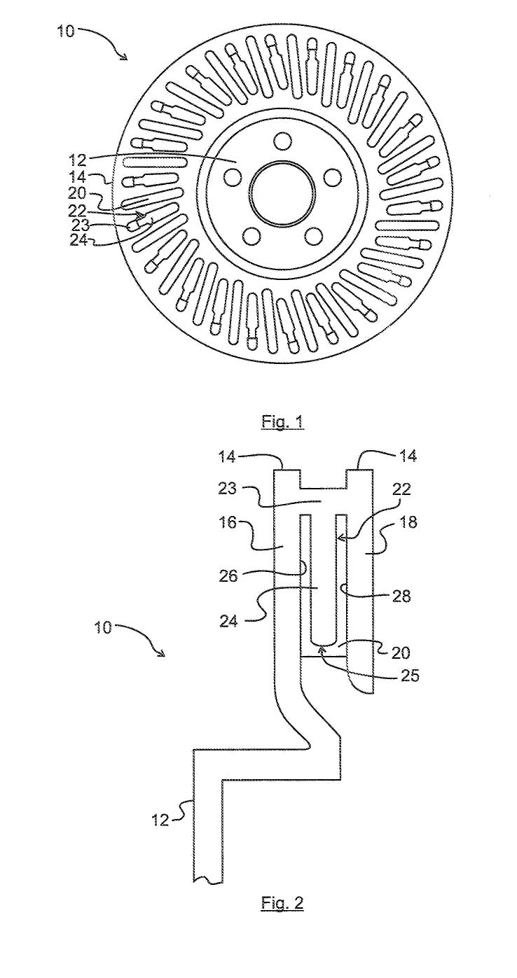

Referring to FIG. 2, in a number of variations the part 10 may include a vented brake rotor including a hub 12 and an annular body 14. The annular body 14 may include a first annular portion 16 or first rotor cheek and a second annular portion 18 or second rotor cheek. The first annular portion 16 may include a first face 26 and the second annular portion 18 may include a second face 28. The annular body 14 may include a plurality of ribs or vanes 20. The plurality of ribs or vanes 20 may be disposed between the first face 26 of the first annular portion 16 and the second face 28 of the second annular portion 18. A plurality of mass dampers 22 may also be disposed between the first face 26 of the first annular portion 16 and the second face 28 of the second annular portion 18 and may be constructed and arranged to function as a tuned vibration absorber or mass dampener. The mass damper 22 may be an integrated portion of the part 10. For example, the part 10 may include a metal casting including at least a body portion 14 and a mass damper 22 extending therefrom wherein the body portion 14 and the mass damper 22 are a continuous un-joined integral single piece of cast metal.

According to one variation, the part 10 may include at least one mass damper 22 that is tuned to damp a single rotor resonance or a plurality of rotor resonance frequencies or vibrational modes. Resonance or vibrational modes may include, but are not limited to, nodal diametrical, nodal circular, compressional, or a combination of various vibrational modes.

In a number of variations, the plurality of mass dampers 22 may have varying shapes and sizes whereby the various shapes and sizes of mass dampers are tuned to damp a plurality of rotor resonance frequencies or vibrational modes.

In a number of variations, the mass dampers 22 may extend from the first face 26 or the second face 28 or from both the first face 26 and the second face 28 so that the mass dampers 22 may be disposed between the first annular portion 16 and the second annular portion 18.

In one variation, the integrated mass dampers 22 may extend from the plurality of ribs 20 so that the mass dampers 22 may be disposed between the first annular portion 16 and the second annular portion 18.

In another variation, the integrated mass dampers 22 may be disposed between the first annular portion 16 and the second annular portion 18 via mechanical attachment such as, but not limited to, welding, bonding, bolting, or other suitable means.

In another variation, the integrated mass dampers 22 may be disposed between the first annular portion 16 and the second annular portion 18 via a one-piece design wherein the integrated mass dampers 22 are cast in place within the part 10 during the casting of the part 10.

In another variation, the integrated mass dampers 22 may be disposed between the first annular portion 16 and the second annular portion 18 via a one-piece design wherein the integrated mass dampers 22 are machined into the part 10 after the part 10 has been manufactured.

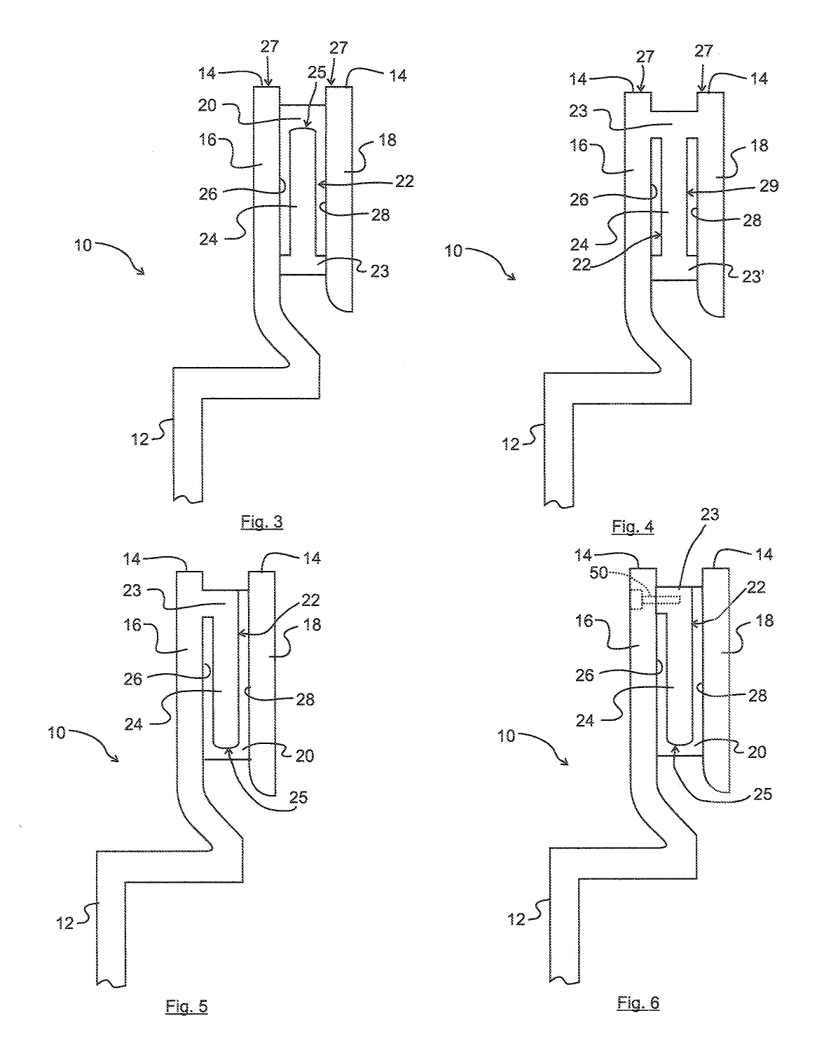

Referring again to FIG. 2, the mass dampers 22 may include an anchor portion 23 extending between the first annular portion 16 and second annular portion 18 at a location nearest an outer annular perimeter 27 of the first annular portion 16 or second annular portion 18 than toward the hub 12. Alternatively, as illustrated in FIG. 3, the anchor portion 23 may extend between the first annular portion 16 and second annular portion 18 at a location nearest the hub 12 than the outer annular perimeter 27 of the first annular portion 16 or second annular portion 18.

As illustrated in FIG. 4, the mass dampers 22 may include a first anchor portion 23 extending between the first annular portion 16 and the second annular portion 18 at a location nearest the outer annular periphery 27 of 16 or 18. A second anchor portion 23′ may extend between the first annular portion 16 and a second annular portion 18. A beam portion 29 may extend between the first anchor portion 23 and the second anchor portion 23′ and may be constructed and arranged to oscillate in a manner which prevents, reduces or reduces the vibration of the vented brake rotor.

In a number of variations illustrated by FIG. 5, the mass dampers 22 may include an anchor portion 23 connected to only one of the first annular portion 16 or second annular portion 18. The mass dampers 22 may have a free end 25 disposed to move about between the first annular portion 16 and second annular portion 18.

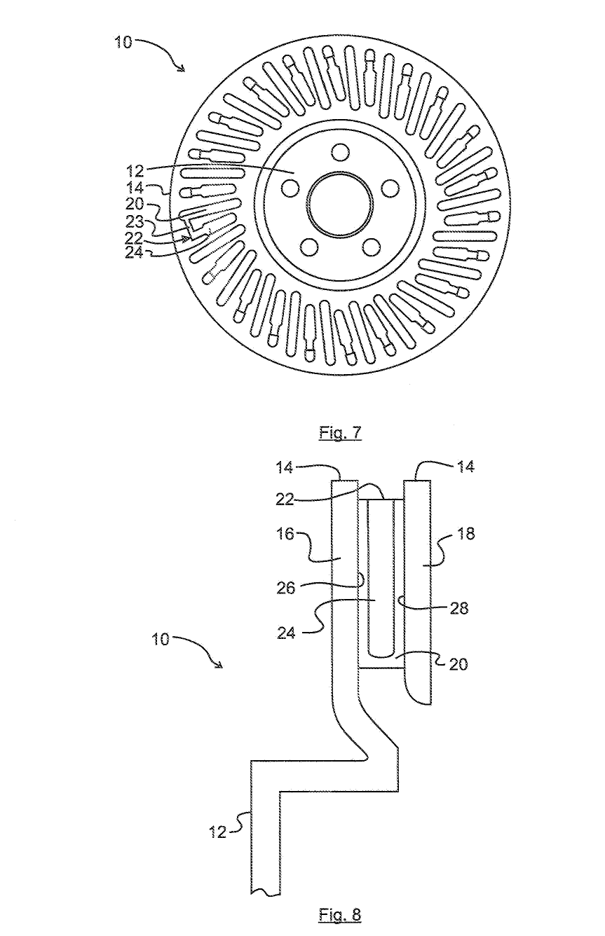

A number of variations are illustrated in FIG. 6, and may include a vented brake rotor 10 can including a mass damper 22 which may be provided as a separate piece which is mechanically attached to one of the first annular portion 16 or second annular portion 18, for example but not limited to, a bolt 50 extending through one of the first annular portion 16 or second annular portion 18 and into the anchor portion 23 of the mass damper 22. Alternatively, the mass damper 22 may be attached to one of the first annular portion 16 or second annular portion 18 by means of welding, bonding or by any of a number of other attachment means.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: a casting including a body portion and a mass damper extending therefrom wherein the body portion and the mass damper are a continuous un-joined single piece of cast metal, and wherein the mass damper is constructed and arranged to prevent, reduce or retard vibrations of the body portion.

Variation 2 may include a product as set forth in Variation 1 wherein the body portion includes an annular portion.

Variation 3 may include a product as set forth in any of Variations 1-2 wherein the body portion includes a first annular portion and a second annular portion, and wherein the mass damper includes an anchor portion connected to at least one of the first annular portion or the second annular portion.

Variation 4 may include a product as set forth in any of Variations 1-3 wherein the anchor portion is connected to both the first annular portion and the second annular portion.

Variation 5 may include a product as set forth in any of Variations 1-4 wherein the body portion includes a first annular portion and a second spaced apart annular portion and at least one rib extending between the first annular portion and the second annular portion, and wherein the mass damper is connected to the rib.

Variation 6 may include a product comprising: a vented brake rotor including a hub and a first annular portion extending from the hub; the annular portion including a first rotor cheek, a second rotor cheek spaced apart from the first rotor cheek and at least one rib extending between the first rotor cheek and the second rotor cheek; a mass damper disposed between the first rotor cheek and the second rotor cheek.

Variation 7 may include a product as set forth in Variation 6 wherein the mass damper includes a first anchor portion and a protrusion or jut extending from the first anchor portion, and wherein the first anchor portion is connected to at least one of the first rotor cheek, the second rotor cheek or the at least one rib.

Variation 8 may include a product as set forth in any of Variations 6-7 wherein the first anchor portion is connected to both the first rotor cheek and the second rotor cheek.

Variation 9 may include a product as set forth in any of Variations 6-8 wherein the first anchor portion connected to the at least one rib.

Variation 10 may include a product as set forth in any of Variations 6-9 wherein the first anchor portion is connected to at least one of the first rotor cheek or second rotor cheek nearest an outer annular periphery thereof.

Variation 11 may include a product as set forth in any of Variations 6-10 wherein the first anchor portion is connected to at least one of the first rotor cheek or second rotor cheek at a location nearest the hub than to an outer annular periphery of one of the first rotor cheek or second rotor cheek.

Variation 12 may include a product as set forth in any of Variations 6-11 wherein the mass damper is mechanically attached to one of the first rotor cheek, second rotor cheek, or the at least one rib.

Variation 13 may include a product as set forth in any of Variations 6-12 wherein the mass damper includes a protrusion or jut extending from the first anchor portion, the protrusion or jut having a free end.

Variation 14 may include a product as set forth in any of Variations 6-13 wherein the mass damper comprises at least one of a composite material, a thermoplastic material, a thermoset material, a ceramic or a metal.

Variation 15 may include a product as set forth in any of Variations 6-14 the mass damper further comprising a second anchor portion extending between the first rotor cheek and the second rotor cheek, and a being portion extending between the first anchor portion and the second anchor portion.

Variation 16 may include a product as set forth in any of Variations 6-15 wherein the mass damper and at least one of the first rotor cheek or second rotor cheek are a continuous integral un-joined single piece.

Variation 17 may include a product as set forth in any of Variations 6-16 further comprising at least one rib extending between the first rotor cheek and the second rotor cheek, and wherein the mass damper and the at least one rib are a continuous integral un-joined single piece.

Variation 18 may include a product as set forth in any of Variations 6-18 wherein the mass damper is mechanically connected to at least one of the first rotor cheek or second rotor cheek.

Variation 19 may include a product as set forth in any of Variations 6-18 further comprising at least one rib extending between the first rotor cheek and the second rotor cheek, and wherein the mass damper is mechanically connected to at least one of the first rotor cheek, second rotor cheek or the at least one rib.

Variation 20 may include brake rotor comprising: a casting including a body portion and a mass damper extending therefrom wherein the body portion and the mass damper are a continuous un-joined single piece of cast metal, and wherein the mass damper is constructed and arranged to prevent, reduce or retard vibrations of the body portion.

The above description of select examples of the invention is merely exemplary in nature and, thus, variations or variants thereof are not to be regarded as a departure from the spirit and scope of the invention.

What is claimed is:

1. A product comprising:
a casting including a body portion and a mass damper extending therefrom wherein the body portion and the mass damper are a continuous un-joined single piece of cast metal, and wherein the mass damper is constructed are arranged to prevent, reduce or retard vibrations of the body portion.

2. A product as set forth in claim 1 wherein the body portion includes an annular portion.

3. A product as set forth in claim 1 wherein the body portion includes a first annular portion and a second annular portion, and wherein the mass damper includes an anchor portion connected to at least one of the first annular portion or the second annular portion.

4. A product as set forth in claim 3 wherein the anchor portion is connected to both the first annular portion and the second annular portion.

5. A product as set forth in claim 1 wherein the body portion includes a first annular portion and a second spaced apart annular portion and at least one rib extending between the first annular portion and the second annular portion, and wherein the mass damper is connected to the rib.

6. A product comprising:
a vented brake rotor including a hub and a first annular portion extending from the hub;
the annular portion including a first rotor cheek, a second rotor cheek spaced apart from the first rotor cheek and at least one rib extending between the first rotor cheek and the second rotor cheek;
a mass damper disposed between the first rotor cheek and the second rotor cheek.

7. A product as set forth in claim 6 wherein the mass damper includes a first anchor portion and a protrusion or jut extending from the first anchor portion, and wherein the first anchor portion is connected to at least one of the first rotor cheek, the second rotor cheek or the at least one rib.

8. A product as set forth in claim 7 wherein the first anchor portion is connected to both the first rotor cheek and the second rotor cheek.

9. A product as set forth in claim 7 wherein the first anchor portion connected to the at least one rib.

10. A product as set forth in claim 7 wherein the first anchor portion is connected to at least one of the first rotor cheek or second rotor cheek nearest an outer annular periphery thereof.

11. A product as set forth in claim 7 wherein the first anchor portion is connected to at least one of the first rotor cheek or second rotor cheek at a location nearest the hub than to an outer annular periphery of one of the first rotor cheek or second rotor cheek.

12. A product as set forth in claim 6 wherein the mass damper is mechanically attached to one of the first rotor cheek, second rotor cheek, or the at least one rib.

13. A product as set forth in claim 6 wherein the mass damper includes a protrusion or jut extending from the first anchor portion, the protrusion or jut having a free end.

14. A product as set forth in claim 6 wherein the mass damper comprises at least one of a composite material, a thermoplastic material, a thermoset material, a ceramic or a metal.

15. A product as set forth in claim 6 the mass damper further comprising a second anchor portion extending between the first rotor cheek and the second rotor cheek, and a being portion extending between the first anchor portion and the second anchor portion.

16. A product as set forth in claim 6 wherein the mass damper and at least one of the first rotor cheek or second rotor cheek are a continuous integral un-joined single piece.

17. A product as set forth in claim 6 further comprising at least one rib extending between the first rotor cheek and the second rotor cheek, and wherein the mass damper and the at least one rib are a continuous integral un-joined single piece.

18. A product as set forth in claim 6 wherein the mass damper is mechanically connected to at least one of the first rotor cheek or second rotor cheek.

19. A product as set forth in claim 6 further comprising at least one rib extending between the first rotor cheek and the second rotor cheek, and wherein the mass damper is mechanically connected to at least one of the first rotor cheek, second rotor cheek or the at least one rib.

20. A brake rotor comprising:
a casting including a body portion and a mass damper extending therefrom wherein the body portion and the mass damper are a continuous un-joined single piece of cast metal, and wherein the mass damper is constructed and arranged to prevent, reduce or retard vibrations of the body portion.
